(19) United States
(12) Patent Application Publication
(10) Pub. No.: US 2011/0314635 A1
(43) Pub. Date: Dec. 29, 2011

(54) HINGE

(75) Inventor: Ching-Yao Chen, KUEISHAN HSIANG (TW)

(73) Assignee: YUAN DENG METALS INDUSTRIAL CO., LTD., KUEISHAN HSIANG (TW)

(21) Appl. No.: 12/825,240

(22) Filed: Jun. 28, 2010

(51) Int. Cl. E05F 1/08

(52) U.S. Cl. 16/277

(57) ABSTRACT

A hinge includes a barrel having a protruding positioning portion arranged therein, a pivot shaft axially and rotatably inserted through the barrel and having a recessed positioning portion located on the periphery for engagement with the protruding positioning portion of the barrel for positioning and a groove disposed at an outer side relative to the recessed positioning portion, and an elastically deformable bearing member mounted in the barrel and having a springy protruding portion stopped against the groove of the pivot shaft to enhance positioning stability of the pivot shaft in the barrel.

### BACKGROUND OF THE INVENTION

1. Field of the Invention

The present invention relates to hinges and more particularly, to such a hinge that uses a spring member to hold down a pivot shaft in a barrel, assuring positioning stability.

2. Description of the Related Art

Hinges are intensively used in many objects in our daily life. For examples, hinges are commonly used in notebook computers, electronic dictionaries, PDAs and many other electronic devices to connect two solid members, allowing only a limited angle of rotation between them. There is known a hinge design that can be positively kept in position by means of engagement between a positioning groove on the pivot shaft thereof and an arched positioning face on the inside wall of the barrel thereof when the two solid members of an object that are respectively affixed to the pivot shaft and barrel of the hinge are closed. However, this design of hinge is not durable in use. After a long use, the positioning groove and the arched positioning face may start to wear due to friction, causing vibration of the pivot shaft relative to the barrel.

### SUMMARY OF THE INVENTION

The present invention has been accomplished under the circumstances in view. It is the main object of the present invention to provide a hinge, which uses an elastically deformable bearing member in the barrel thereof to stop against the pivot shaft, enhancing positioning stability of the pivot shaft in the barrel and avoiding vibration of the members of the object using the hinge.

It is another object of the present invention to provide a hinge, which enables the pivot shaft to receive different torque values during rotation subject to the elastically biasable and elastically displaceable characteristics of the bearing spring member, so that the hinge is practical for use in a notebook computer, electronic dictionary, or any of a variety of other electronic products.

To achieve these and other objects of the present invention, a hinge comprises a barrel having a protruding positioning portion arranged therein, a pivot shaft axially and rotatably inserted through the barrel and having a recessed positioning portion located on the periphery for engagement with the protruding positioning portion of the barrel for positioning and a groove disposed at an outer side relative to the recessed positioning portion, and an elastically deformable bearing member mounted in the barrel and having a springy protruding portion stopped against the groove of the pivot shaft to enhance positioning stability of the pivot shaft in the barrel.

### BRIEF DESCRIPTION OF THE DRAWINGS

FIG. 1 is an oblique elevation of a hinge in accordance with a first embodiment of the present invention.

FIG. 2 is a schematic side view of a part of the hinge in accordance with the first embodiment of the present invention, showing the springy protruding portion of the bearing spring member stopped against the groove of the pivot shaft.

FIG. 3 is a sectional side view of the hinge in accordance with the first embodiment of the present invention, showing the recessed positioning portion of the pivot shaft engaged with the protruding positioning portion of the barrel.

FIG. 4 is similar to FIG. 2, showing the pivot shaft rotated relative to the bearing spring member.

FIG. 5 is similar to FIG. 3, showing the recessed positioning portion moved with the pivot shaft relative to the protruding positioning portion of the barrel.

FIG. 6 is similar to FIG. 4, showing the pivot shaft rotated relative to the bearing spring member.

FIG. 7 is similar to FIG. 5, showing the recessed positioning portion of the pivot shaft moved away from the protruding positioning portion of the barrel.

FIG. 8 is an oblique elevation of a hinge in accordance with a second embodiment of the present invention.

FIG. 9 is a schematic side view of a part of the hinge in accordance with the second embodiment of the present invention, showing the springy protruding portion of the bearing spring member stopped against the groove of the pivot shaft.

FIG. 10 is a sectional side view of the hinge in accordance with the second embodiment of the present invention, showing the recessed positioning portion of the pivot shaft engaged with the protruding positioning portion of the barrel.

FIG. 11 is similar to FIG. 9, showing the pivot shaft rotated relative to the bearing spring member.

FIG. 12 is similar to FIG. 10, showing the recessed positioning portion moved with the pivot shaft relative to the protruding positioning portion of the barrel.

FIG. 13 is similar to FIG. 11, showing the pivot shaft rotated relative to the bearing spring member.

FIG. 14 is similar to FIG. 12, showing the recessed positioning portion of the pivot shaft moved away from the protruding positioning portion of the barrel.

### DETAILED DESCRIPTION OF THE PREFERRED EMBODIMENT

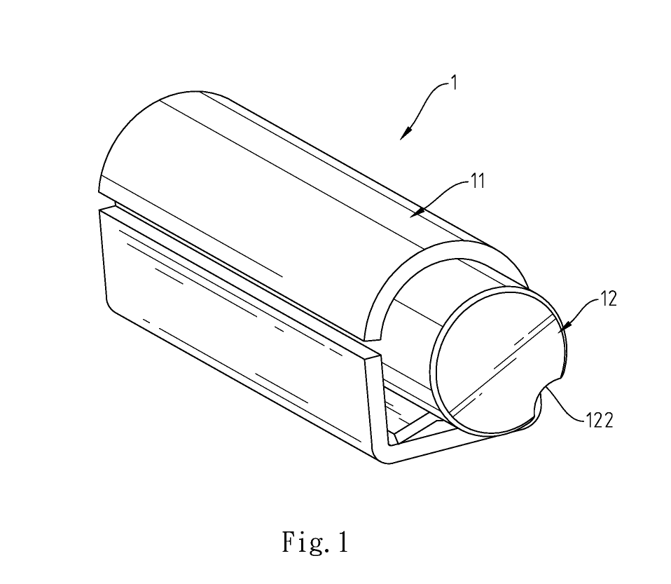

Referring to FIGS. 1˜3, a hinge 1 in accordance with the present invention is shown comprising a barrel 11, a pivot shaft 12 and a bearing spring member 13.

The barrel 11 has a protruding positioning portion 111 arranged therein. The pivot shaft 12 is axially inserted through the barrel 11, having a recessed positioning portion 121 located on the periphery and fitting the protruding positioning portion 111 of the barrel 11 for positioning, and a groove 122 located on the periphery at an outer side relative to the recessed positioning portion 121. The bearing spring member 13 is mounted in the barrel 11, having a springy protruding portion 131 stopped against the groove 122 of the pivot shaft 12. The bearing spring member 13 is a spring member. The springy protruding portion 131 is formed of one end of the spring member. Thus, when rotating the pivot shaft 12 relative to the barrel 11, the springy protruding portion 131 of the bearing spring member 13 is forced by the groove 122 to bias.

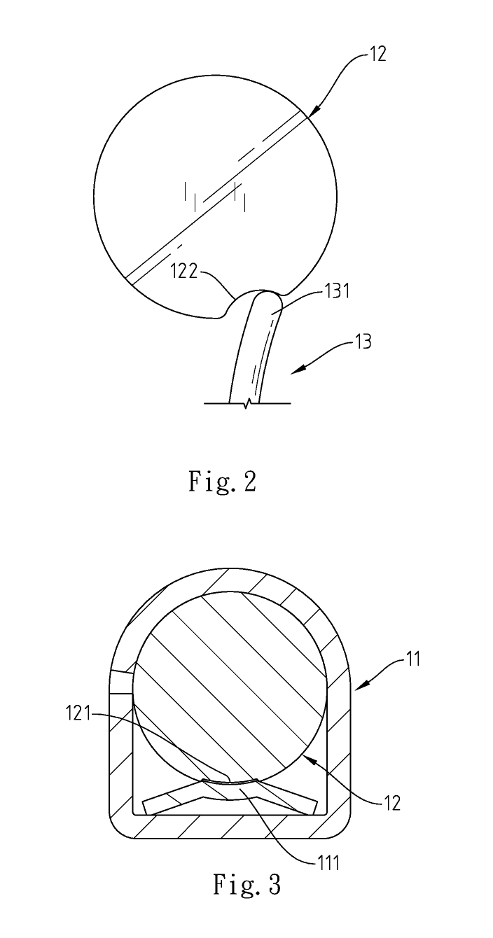

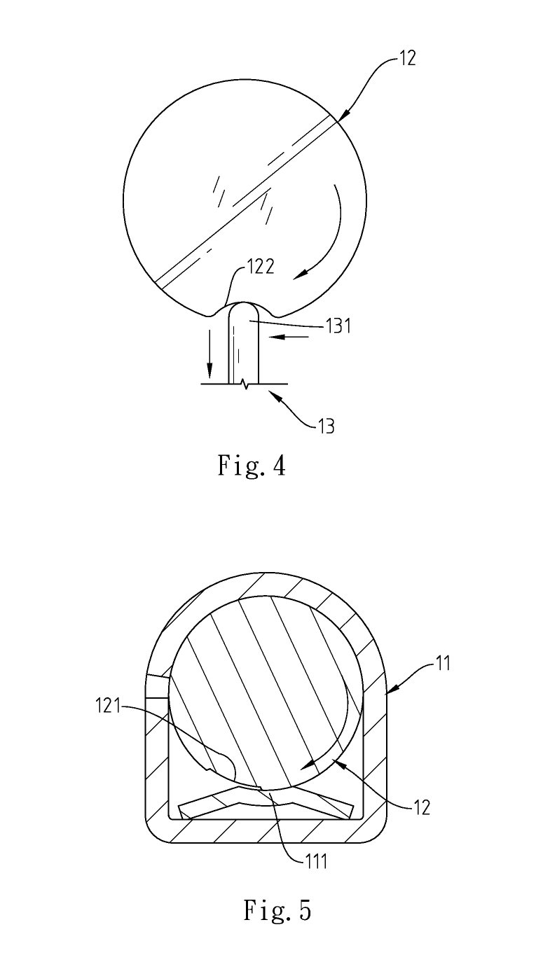

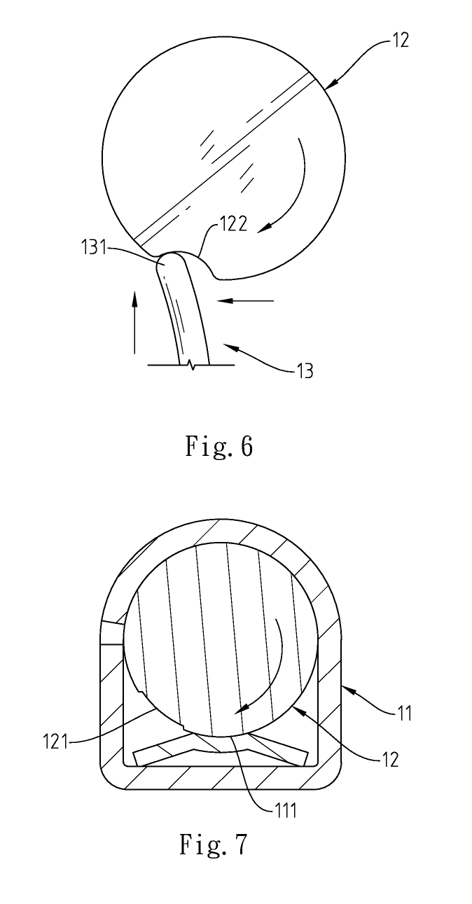

As shown in FIGS. 2˜7, when the barrel 11 and pivot shaft 12 of the hinge 1 are respectively affixed to two component parts of an object (not shown) and the object is kept in a normal position (for example, the close position), the protruding positioning portion 111 of the barrel 11 and the recessed positioning portion 121 of the pivot shaft 12 are fitted against each other, and the springy protruding portion 131 of the bearing spring member 13 is stopped against the groove 122 of the pivot shaft 12 to force the recessed positioning portion 121 of the pivot shaft 12 into positive engagement with the protruding positioning portion 111 of the barrel 11, therefore, no any gap is left in between the recessed positioning portion 121 of the pivot shaft 12 and the protruding positioning portion 111 of the barrel 11. Thus, the pivot shaft 12 is positively held in position and prohibited from rotation or vibration relative to the barrel 11. When the user moves the two component parts of the object to bias the pivot shaft 12 of the hinge 1 relative to the barrel 11 (see the arrowhead sign), the recessed positioning portion 121 of the pivot shaft 12 is being moved away from the protruding positioning portion 111 of the barrel 11, and at the same time, the groove 122 of the pivot shaft 12 is moved with the pivot shaft 12 to bias the springy protruding portion 131 of the bearing spring member 13. At this time, the springy protruding portion 131 of the bearing spring member 13 imparts a thrust force to the pivot shaft 12 in a direction reversed to the direction of rotation of the pivot shaft 12. Therefore, a high torsional force must be applied to the pivot shaft 12 so that the recessed positioning portion 121 of the pivot shaft 12 can be disengaged from the protruding positioning portion 111 of the barrel 11. When the middle part the groove 122 of the pivot shaft 12 is moved over the springy protruding portion 131 of the bearing spring member 13 during rotation of the pivot shaft 12 relative to the barrel 11, the spring force applied by the springy protruding portion 131 of the bearing spring member 13 to the groove 122 of the pivot shaft 12 becomes same as the direction of rotation of the pivot shaft 12, facilitating rotation of the pivot shaft 1.

Further, when reversing the pivot shaft 12 to move the recessed positioning portion 121 into engagement with the protruding positioning portion 111 of the barrel 11, the groove 122 is moved with the pivot shaft 12 to bias the springy protruding portion 131 of the bearing spring member 13. At this time, the springy protruding portion 131 of the bearing spring member 13 imparts a thrust force to the pivot shaft 12 in a direction reversed to the direction of rotation of the pivot shaft 12. Therefore, a high torsional force must be applied to the pivot shaft 12 so that the recessed positioning portion 121 of the pivot shaft 12 can be forced into engagement with the protruding positioning portion 111 of the barrel 11. When the middle part the groove 122 of the pivot shaft 12 is moved over the springy protruding portion 131 of the bearing spring member 13 during rotation of the pivot shaft 12 relative to the barrel 11, the spring force applied by the springy protruding portion 131 of the bearing spring member 13 to the groove 122 of the pivot shaft 12 becomes same as the direction of rotation of the pivot shaft 12, facilitating rotation of the pivot shaft 12 to force the recessed positioning portion 121 into engagement with the protruding positioning portion 111 of the barrel 11.

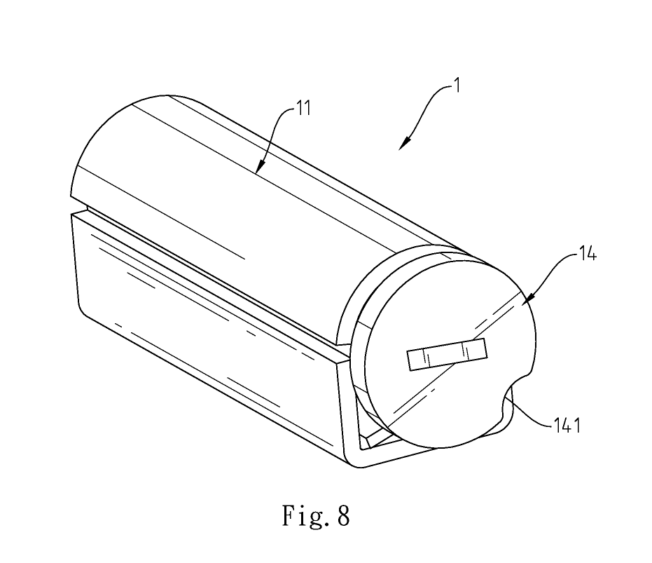

FIGS. 8˜14 show a hinge in accordance with a second embodiment of the present invention. According to this second embodiment, the hinge 1 comprises a barrel 11, a pivot shaft 12, a bearing spring member 13 and a locating plate 14.

The barrel 11 has a protruding positioning portion 111 arranged therein. The pivot shaft 12 is axially inserted through the barrel 11, having a recessed positioning portion 121 located on the periphery and fitting the protruding positioning portion 111 of the barrel 11 for positioning. The locating plate 14 is fixedly located on one end of the pivot shaft 12, having a groove 141 located on the periphery thereof. The bearing spring member 13 is mounted in the barrel 11, having a springy protruding portion 131 stopped against the groove 141 of the locating plate 14. The bearing spring member 13 is a spring plate. The springy protruding portion 131 is formed of one end of the spring member. Thus, when rotating the pivot shaft 12 relative to the barrel 11, the springy protruding portion 131 of the bearing spring member 13 is forced by the groove 141 to bias.

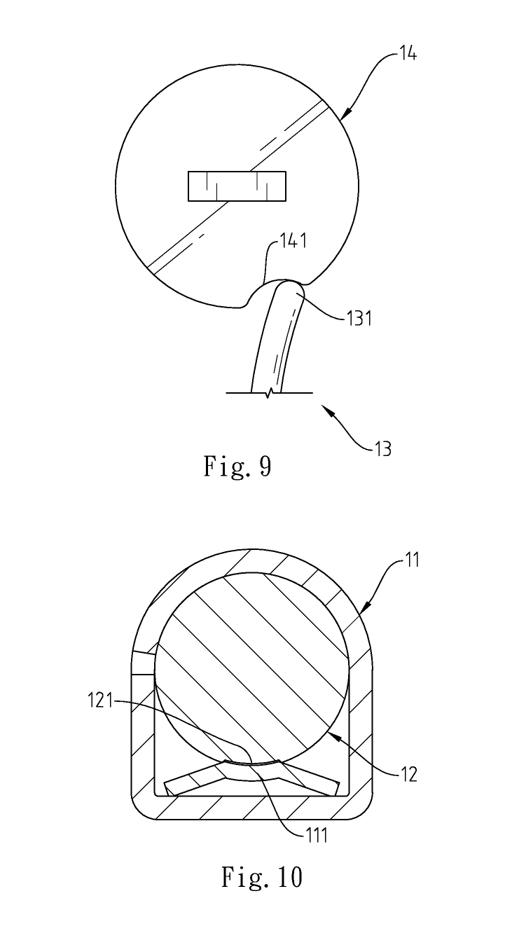

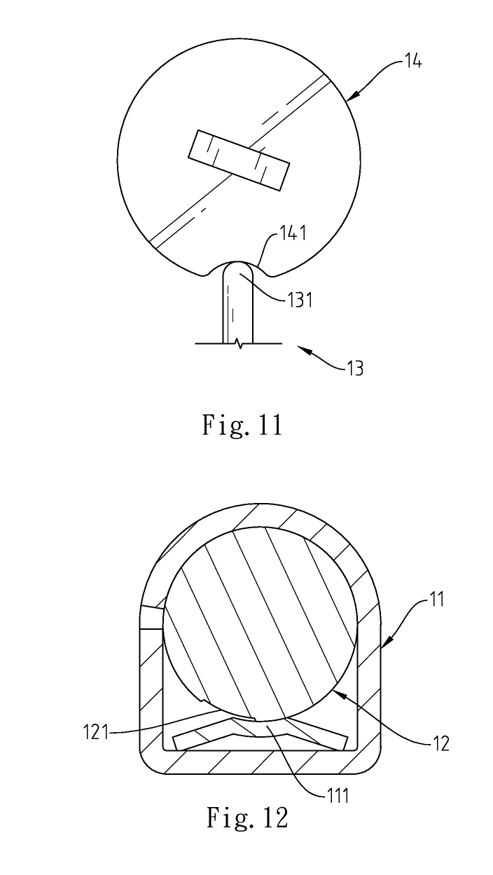

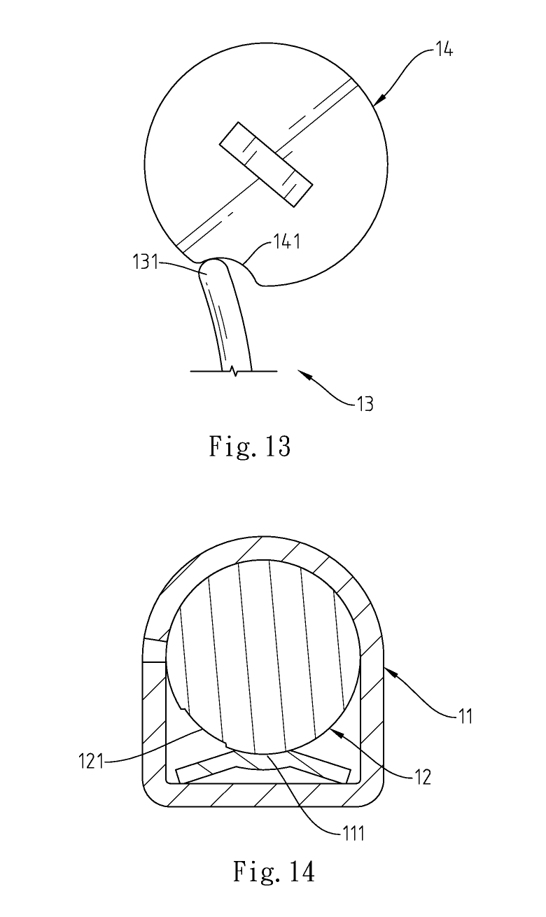

As shown in FIGS. 9˜14, when the barrel 11 and pivot shaft 12 of the hinge 1 are respectively affixed to two component parts of an object (not shown) and the object is kept in a normal position (for example, the close position), the protruding positioning portion 111 of the barrel 11 and the recessed positioning portion 121 of the pivot shaft 12 are fitted against each other, and the springy protruding portion 131 of the bearing spring member 13 is stopped against the groove 141 of the locating plate 14 to force the recessed positioning portion 121 of the pivot shaft 12 into positive engagement with the protruding positioning portion 111 of the barrel 11, therefore, no any gap is left in between the recessed positioning portion 121 of the pivot shaft 12 and the protruding positioning portion 111 of the barrel 11. Thus, the pivot shaft 12 is positively held in position and prohibited from rotation or vibration relative to the barrel 11. When the user moves the two component parts of the object to bias the pivot shaft 12 of the hinge 1 relative to the barrel 11, the recessed positioning portion 121 of the pivot shaft 12 is being moved away from the protruding positioning portion 111 of the barrel 11, and at the same time, the groove 141 of the locating plate 14 is moved with the pivot shaft 12 to bias the springy protruding portion 131 of the bearing spring member 13. At this time, the springy protruding portion 131 of the bearing spring member 13 imparts a thrust force to the pivot shaft 12 in a direction reversed to the direction of rotation of the pivot shaft 12. Therefore, a high torsional force must be applied to the pivot shaft 12 so that the recessed positioning portion 121 of the pivot shaft 12 can be disengaged from the protruding positioning portion 111 of the barrel 11. When the middle part the groove 141 of the locating plate 14 is moved over the springy protruding portion 131 of the bearing spring member 13 during rotation of the pivot shaft 12 relative to the barrel 11, the spring force applied by the springy protruding portion 131 of the bearing spring member 13 to the groove 141 of the locating plate 14 becomes same as the direction of rotation of the pivot shaft 12, facilitating rotation of the pivot shaft 1.

Further, when reversing the pivot shaft 12 to move the recessed positioning portion 121 into engagement with the protruding positioning portion 111 of the barrel 11, the groove 141 is moved with the locating plate 14 and the pivot shaft 12 to bias the springy protruding portion 131 of the bearing spring member 13. At this time, the springy protruding portion 131 of the bearing spring member 13 imparts a thrust force to the locating plate 14 and the pivot shaft 12 in a direction reversed to the direction of rotation of the pivot shaft 12. Therefore, a high torsional force must be applied to the pivot shaft 12 so that the recessed positioning portion 121 of the pivot shaft 12 can be forced into engagement with the protruding positioning portion 111 of the barrel 11. When the middle part the groove 141 of the locating plate 14 is moved over the springy protruding portion 131 of the bearing spring member 13 during rotation of the pivot shaft 12 relative to the barrel 11, the spring force applied by the springy protruding portion 131 of the bearing spring member 13 to the groove 141 of the locating plate 14 becomes same as the direction of rotation of the pivot shaft 12, facilitating rotation of the pivot shaft 12 to force the recessed positioning portion 121 into engagement with the protruding positioning portion 111 of the barrel 11.

In conclusion, the hinge 1 has the following features and advantages:

1. When the recessed positioning portion 121 of the pivot shaft 12 and the protruding positioning portion 111 of the barrel 11 are matched together, the bearing spring member 13 imparts a spring force to the pivot shaft 12 against the barrel 11, avoiding any gap in between the recessed positioning portion 121 of the pivot shaft 12 and the protruding positioning portion 111 of the barrel 11 and enhancing positioning stability of the pivot shaft 12, and therefore the members of the object using the hinge 1 will not vibration when positioned.

2. By means of the elastically biasable and elastically displaceable characteristics of the bearing spring member 13, the pivot shaft 12 can receive different torque values during rotation, so that the hinge 1 is practical for use in a notebook computer, electronic dictionary, or any of a variety of other electronic products.

Although particular embodiments of the invention have been described in detail for purposes of illustration, various modifications and enhancements may be made without departing from the spirit and scope of the invention.

What the invention claimed is:

1. A hinge, comprising:
a barrel, said barrel comprising a protruding positioning portion arranged therein;
a pivot shaft axially and rotatably inserted through said barrel, said pivot shaft comprising a recessed positioning portion located on the periphery and fitting the protruding positioning portion of said barrel for positioning, and a groove; and
an elastically deformable bearing member mounted in said barrel, said elastically deformable bearing member comprising a springy protruding portion stopped against the groove of said pivot shaft.

2. The hinge as claimed in claim 1, wherein said groove is located on the periphery of said pivot shaft at an outer side relative to said recessed positioning portion.

3. The hinge as claimed in claim 1, wherein said pivot shaft has one end fixedly mounted with a locating plate; said groove is located on the periphery of said locating plate.

4. The hinge as claimed in claim 1, wherein said elastically deformable bearing member is a spring member; said springy protruding portion is formed of a part of one end of said spring member.
